(19) United States
(12) Patent Application Publication
(10) Pub. No.: US 2016/0029442 A1
(43) Pub. Date: Jan. 28, 2016

(54) A DOOR FOR A MICROWAVE APPLIANCE

(71) Applicant: ELECTROLUX APPLIANCES AKTIEBOLAG, Stockholm (SE)

(72) Inventor: Omar Houbloss, Plouzané (FR)

(73) Assignee: Electrolux Appliances Aktiebolag, Stockholm (SE)

(21) Appl. No.: 14/758,886

(22) PCT Filed: Feb. 13, 2014
(86) PCT No.: PCT/EP2014/052770

§ 371 Date: Jul. 1, 2015

(30) Foreign Application Priority Data
Mar. 4, 2013 (EP) 13157617.5

(51) Int. Cl. H05B 6/76; F24C 15/04

(52) U.S. Cl. CPC H05B 6/763; H05B 6/766; F24C 15/04

(57) ABSTRACT

A door for a microwave appliance. The door includes an outer glass panel ranging over a complete outer side of the door and an inner glass panel ranging over at least a central portion of an inner side of the door. The door includes a door frame covering at least the circumferential sides of the oven door and a wave choke system. The outer glass panel, the inner glass panel and the door frame form a casing of the door, wherein the wave choke system is arranged inside the casing of the door. The wave choke system is arranged in an outer portion of the interior of the door and circumferentially enclosed by the door frame. The wave choke system is arranged adjacent to an outer side of the inner glass panel.

The present invention relates to a door for a microwave appliance. In particular, the present invention relates to an oven door for a microwave oven or a multifunctional oven with microwave heating function. Further, the present invention relates to a microwave appliance. Moreover, the present invention relates to m a microwave oven or a multifunctional oven with microwave heating function.

In a microwave appliance the leakage between a door and an opening has to be minimized. For this purpose, a wave choke system is arranged in the outer portions inside the door. The dimensions of the wave choke system result in a small window in the central portion of the door. In a similar way, the dimensions of a door frame made of plastics also contribute to the small window in the door. Said small window limits the view into the inner space of the microwave appliance.

It is an object of the present invention to provide a door for a microwave appliance, which allows an improved view into the inner space of the microwave appliance.

The object of the present invention is achieved by the door for a microwave appliance according to claim 1.

The present invention relates to a door for a microwave appliance, wherein:
the door includes an outer glass panel ranging over a complete outer side of the door,
the door includes an inner glass panel ranging over at least a central portion of an inner side of the door,
the door includes a door frame covering at least the circumferential sides of the oven door,
the door includes a wave choke system,
the outer glass panel, the inner glass panel and the door frame form a casing of the door,
the wave choke system is arranged inside said casing of the door,
the wave choke system is arranged in an outer portion of the interior of the door and circumferentially enclosed by the door frame,
the wave choke system is arranged adjacent to an outer side of the inner glass panel, and
the circumferential sides of the inner glass panel are enclosed by the door frame.

The main idea of the present invention is that the outer glass panel ranges over the complete outer side of the door on the one hand and the inner glass panel ranges over the substantially complete inner side of the door on the other hand. The circumferential sides of the door are covered by the door frame. Additionally, the outer portions of the inner side of said door are also covered by the door frame. Thus, the outer glass panel, the inner glass panel and the door frame form the casing of the door, wherein the wave choke system is arranged inside said casing. The door has a compact form with smooth surfaces. Since the wave choke system is adjacent to the outer side of the inner glass panel, said inner glass panel is relative large and the door allows an improved view through said door into a cavity of the microwave appliance.

According to preferred embodiment of the present invention the door frame is made of plastics.

Further, at least one intermediate glass panel may be arranged between the wave choke system and the outer glass panel.

According to a preferred embodiment of the present invention the wave choke system includes a G-shaped profile.

In particular, the wave choke system includes at least one lamellae structure.

For example, the lamellae structure is arranged beside a gap of the G-shaped profile of the wave choke system.

Preferably, the lamellae structure is arranged adjacent to an outer side of the inner glass panel. The inner glass panel may have a relative high thickness.

Further, a gap between the circumferential sides of the inner glass panel and the door frame may be filled by a gasket. This contributes to a smooth surface of the door.

Moreover, a bending up of the wave choke system penetrates at least partially into the gap between the circumferential sides of the inner glass panel and the door frame.

In particular, the door is an oven door for a microwave oven.

Further, the present invention relates to a microwave appliance, wherein said microwave appliance includes at least one door mentioned above.

For example, the microwave appliance is a microwave oven.

Preferably, the microwave appliance comprises a cavity and a front frame, wherein the front frame encloses circumferentially a front opening of the cavity.

Furthermore, a gap between the front frame and the front opening of the cavity is filled by a gasket.

At last, the wave choke system of the door may extend in parallel to the gap between the front frame and the front opening of the cavity in a closed state of said door

Novel and inventive features of the present invention are set forth in the appended claims.

The present invention will be described in further detail with reference to the drawings, in which

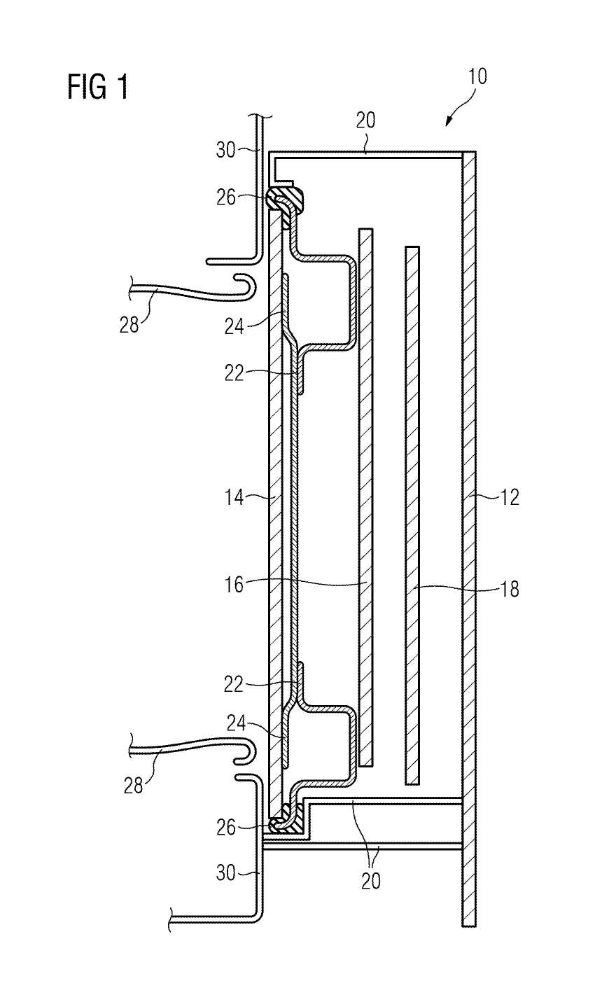

FIG. 1 illustrates a schematic sectional side view of an oven door for a microwave oven or a multifunctional oven with microwave heating function according to a preferred embodiment of the present invention, and

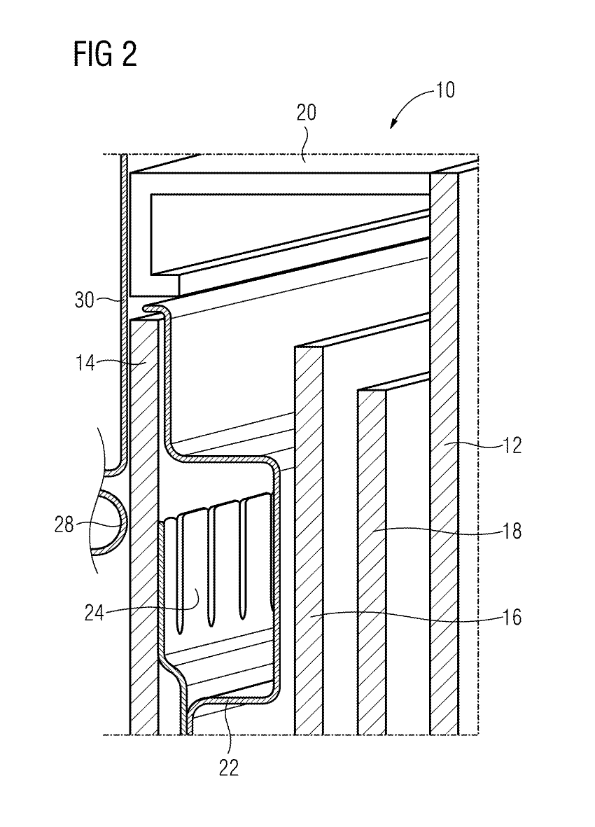

FIG. 2 illustrates a schematic sectional perspective view of an upper part of the oven door for the microwave oven or multifunctional oven with microwave heating function according to the preferred embodiment of the present invention.

FIG. 1 illustrates a schematic sectional side view of an oven door 10 for a microwave oven or a multifunctional oven with microwave heating function according to a preferred embodiment of the present invention. The oven door 10 is attached at a microwave oven. In FIG. 1 the oven door 10 is in a closed state.

The oven door 10 comprises an outer glass panel 12, an inner glass panel 12, a first intermediate glass panel 16, a second intermediate glass panel 18, a door frame 20 and a wave choke system 22. The microwave oven includes an oven cavity 28 and a front frame 30.

The outer glass panel 12 forms the outer side of the oven door 10 and is attached at the door frame 20. The area of the outer glass panel 12 is bigger than that area spanned by the door frame 20. Thus, the outer glass panel 12 covers completely the door frame 20. The inner glass panel 12 forms the substantial part of the inner side of the oven door 10. The circumferential sides of the inner glass panel 12 are enclosed by the door frame 20. In this example, the door frame 20 is made of plastics. The door frame 20 may either be formed as a single-piece part or composed by several frame parts. The wave choke system 22 is made of metal sheets.

The wave choke system 22, the first intermediate glass panel 16 and the second intermediate glass panel 18 are arranged between the outer glass panel 12 and the inner glass panel 12. The wave choke system 22 is adjacent to the outer side of the inner glass panel 12. The first intermediate glass panel 16 is arranged in front of the wave choke system 22. In turn, the second intermediate glass panel 18 is arranged in front of the first intermediate glass panel 16. The door frame encloses circumferentially also the wave choke system 22, the first intermediate glass panel 16 and the second intermediate glass panel 18.

The wave choke system 22 includes a G-shaped profile extending in parallel to the front frame 30 of the microwave oven. The G-shaped profile forms a rectangular frame enclosed by the door frame 20. A gap of the G-shaped profile extends in parallel to a gap between the oven cavity 28 and the front frame 30 of the microwave oven. A profile section besides the gap of the G-shaped profile includes a lamellae structure 24. The lamellae structure 24 is adjacent to the outside of the inner glass panel 14. The plane of the lamellae structure 24 extends in parallel to the inner glass panel 14.

A circumferential gap between the inner glass panel 14 and the door frame 20 is filled by a gasket 26. Further, said gasket 26 encloses partially a bending up of the wave choke system 22. Said bending up encloses the wave choke system 22 and penetrates partially into the gap between the inner glass panel 14 and the door frame 20.

FIG. 2 illustrates a schematic sectional perspective view of an upper part of the oven door 10 for the microwave oven or the multifunctional oven with microwave heating function according to the preferred embodiment of the present invention.

In particular, FIG. 2 shows the geometric properties of the wave choke system 22 including the lamellae structure 24. Further, the arrangements of the outer glass panel 12, the inner glass panel 12, the first intermediate glass panel 16, the second intermediate glass panel 18 and the door frame 20 are shown. For clarity, the gasket 26 is not shown in FIG. 2.

The oven door 10 allows an improved view through said oven door 10 into the oven cavity 28. The oven door 10 has a compact form with smooth surfaces. Since the inner glass panel 14 ranges over the nearly complete inner side of the oven door 10, said inner side may be cleaned up in an easy way. The oven door 10 allows a leakage below 1 mW/cm². This value results from the structure and profile of the wave choke system 22.

The present invention is not restricted to the oven door 10 for the microwave oven. In general, the present invention relates to a door for a microwave appliance and a corresponding microwave appliance.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 oven door

12 outer glass panel

14 inner glass panel

16 first intermediate glass panel

18 second intermediate glass panel

20 door frame

22 wave choke system

24 m 24 lamellae structure

26 gasket

28 oven cavity

30 front frame

What is claimed is:

1. A door (10) for a microwave appliance, wherein:
the door (10) includes an outer glass panel (12) ranging over a complete outer side of the door (10),
the door (10) includes an inner glass panel (14) ranging over at least a central portion of an inner side of the door (10),
the door (10) includes a door frame (20) covering at least the circumferential sides of the oven door (10),
the door (10) includes a wave choke system (22),
the outer glass panel (12), the inner glass panel (14) and the door frame (20) form a casing of the door (10),
the wave choke system (22) is arranged inside said casing of the door (10),
the wave choke system (22) is arranged in an outer portion of the interior of the door (10) and circumferentially enclosed by the door frame (20),
the wave choke system (22) is arranged adjacent to an outer side of the inner glass panel (14), and
the circumferential sides of the inner glass panel (14) are enclosed by the door frame (20).

2. The door according to claim 1,
characterized in that
the door frame (20) is made of plastics.

3. The door according to claim 1,
characterized in that
at least one intermediate glass panel (16, 18) is arranged between the wave choke system (22) and the outer glass panel (12).

4. The door according to claim 1,
characterized in that
the wave choke system (22) includes a G-shaped profile.

5. The door according to claim 1,
characterized in that
the wave choke system (22) includes at least one lamellae structure (24).

6. The door according to claim 4,
characterized in that
the lamellae structure (24) is arranged beside a gap of the G-shaped profile of the wave choke system (22).

7. The door according to claim 5,
characterized in that
the lamellae structure (24) is arranged adjacent to an outer side of the inner glass panel (14).

8. The door according to claim 1,
characterized in that
a gap between the circumferential sides of the inner glass panel (14) and the door frame (20) is filled by a gasket (26).

9. The door according to claim 1,
characterized in that
a bending up of the wave choke system (22) penetrates at least partially into the a gap between the circumferential sides of the inner glass panel (14) and the door frame (20).

10. The door according to claim 1,
characterized in that
the door is an oven door (10) for a microwave oven.

11. A microwave appliance including at least one door (10),
characterized in that
the microwave appliance includes at least one door (10) according to claim 1.

12. The microwave appliance according to claim 11,
characterized in that
the microwave appliance is a microwave oven.

13. The microwave appliance according to claim 11 or 12,
characterized in that
the microwave appliance comprises a cavity (28) and a front frame (30), wherein the front frame (30) encloses circumferentially a front opening of the cavity (28).

14. The microwave appliance according to claim 13,
characterized in that
a gap between the front frame (30) and the front opening of the cavity (28) is filled by a gasket.

5. The microwave appliance according to claim 13,
characterized in that
the wave choke system (22) of the door (10) extends in parallel to the gap between the front frame (30) and the front opening of the cavity (28) in a closed state of said door (10).
